(19) United States
(12) Patent Application Publication
(10) Pub. No.: US 2002/0133722 A1
(43) Pub. Date: Sep. 19, 2002

(54) Broadband services system and method

(76) Inventors: Dov Levanon, Hod Hasharon (IL); Ezer Goshen, Or Yehuda (IL); Ilya Kushnirsky, Nes Ziona (IL); Yulia Azarina, Tel Aviv (IL)

Correspondence Address: Y. ROCKY TSAO, Fish & Richardson P.C., 225 Franklin Street, Boston, MA, 02110-2804, US

(21) Appl. No.: 09/812,069

(22) Filed: Mar. 19, 2001

(51) Int. Cl. H04L 9/32

(52) U.S. Cl. 713/201

(57) ABSTRACT

A broadband system (20) provides access to remote services to a number of user terminals (30, 35, 40, 45, 46) over a broadband network, the system (20) storing data about the services and data about users, wherein the system is arranged to receive requests from user terminals for access to the services and to authorise access to the services in dependence on the stored data, wherein upon authorising access to a service for a user at a user terminal, the system is arranged to use the data stored about the service to redirect the user terminal to access the service and to record subsequent events occurring between the user terminal and the service.

### FIELD OF THE INVENTION

The present invention relates to a system for a broadband network that is suitable for hosting content for access by users.

### BACKGROUND TO THE INVENTION

Broadband access networks such as xDSL, cable TV and fixed wireless networks that provide multiple channels of data over a single communication medium are becoming increasingly widespread. Until recently, broadband access providers have focused on using their networks to provide high speed Internet access. In the case of ADSL, the high bandwidth downlink and limited bandwidth uplink available is ideal for typical Internet users who spend most of their time receiving data and very little transmitting.

It has recently been realised that this is also the case for most multimedia content provision and associated services provided to users and businesses. Content such as video, music, games and the like is desirable on an on-demand basis to users homes and to businesses. Whilst television and radio broadcasts are popular due to the variation in content, many users wish to be able to receive content based on their schedule and lifestyle. This demand is reflected by the popularity of video rental as opposed to going to the cinema. With a video, you are in control of when the movie is played, paused etc. Therefore there are an increasing number of parties interested in providing this content and associated services in an on-demand basis.

Although on-demand service provision has been attempted over the Internet, the congestion, bottlenecks and unreliability of the Internet has prevented such services being provided to mainstream audiences. Realising that broadband networks offer the quality of service and reliable availability of bandwidth that the Internet lacks, broadband network providers are now developing on-demand services. The services are intended to provide multi media services and content to end users and businesses over the networks.

Broadband service systems are being provided in broadband networks to offer such content and services. Users logon to the system via terminals in their homes or businesses and can access the content and services offered by the system through a user interface. Broadband service systems implemented to-date vary from basic computer servers to complex computer systems incorporating specific hardware for video streaming, telecommunications and the like.

The user interface provided by broadband service systems to user terminals is normally designed to offer simple, user friendly access to the content and services. The user interface is commonly in the form of pages of text and menus that can be navigated using a simple control device such as a television remote control In order to keep the interface simple and easy to use, the interface is specifically written for the content and se ices provided by the computer system. Because many of the broadband network access providers are also attempting to be service and content providers, they have access to all the network hardware including the broadband service systems and can make the necessary changes to the user interface if the content or services change.

Where an outside party wishes to be a content provider and/or a service provider, he or she must provide the content and services to the network access provider who integrates them into the user interface of their broadband service systems. This arrangement results in a large amount of work for the network access provider in maintaining and supporting the system and limits the flexibility that can be offered to content and service providers in terms of their contents and services. The user sees this as delays in the availability of new content and services and increased downtime whilst services are being updated.

Development of a service system starts from scratch or from a pre-existing service application. The service system is written or adapted to communicate with user terminals and to be integrated with the user interface of the service system. Facilities for security, authorization and authentication, accounting, billing, management of the service itself and management of any associated content must be written and integrate the service system with service applications.

Even where an outside party reaches an agreement with a network access provider for the third party to install and support his own broadband service system in the broadband network to provide content and services, because the user interface is written specifically for the content and services offered, integration of new content and services is complex and time consuming and results in different computer systems being provided for different services from the same or different service providers. From a user's point of view, a number of methods must be used to access these different services and a number of subscriptions to different parties must be maintained to have access to their respective content and services.

The present invention seeks to provide a system for hosting broadband service provision that is able to offer a generic portal to any number of different content and services. In particular, the system seeks to provide the functions and services required to operate a service irrespective of the service type or operation.

### STATEMENT OF THE INVENTION

According to a first aspect of the present invention, there is provided a broadband system for providing access to remote services to a number of user terminals over a broadband network the system storing data about the services and data about users, wherein the system is arranged to receive requests from user terminals for access to the services and to authorise access to the services in dependence on the stored data, wherein upon authorising access to a service for a user at a user terminal, the system is arranged to use the data stored about the service to redirect the user terminal to access the service and to record subsequent events occurring between the user terminal and the service.

The system may be arranged to dynamically generate a user interface for use by a user on a user terminal for accessing the services, the interface being generated in dependence on the data stored about the services and the data stored about the user,

Data stored about a service may include data on the availability of the service, wherein a user interface is only generated to allow access to a service if the data indicates it is available. Data stored about a user may include data on a user's subscription to the system, wherein a user interface is only generated to allow access to a service if the data on the user's subscription indicates the user's subscription covers that service. Data stored about a user may include data on restrictions to access of services from the system, wherein a user interface is only generated to allow access to a service if the data on restrictions does not prohibit access to the service. Access to a service from the user interface may be via a link, wherein a generated user interface may include a link to a service if the user's subscription covers that service, the data about the service indicates it is available and the user is not restricted from accessing that service.

Data stored about a service may include the service's address, wherein upon aathorising access, the system may use the address to instruct the user terminal to communicate with the service at the address.

The or each service may be arranged to communicate events that occur between the user terminal and the service to the system for recordal.

The system may include an adapter for passing communications and events between a service and the system, the adapter being arranged to capture and convert necessary communications and events from the service into a form processable by the system and to transmit them to the system for recordal.

When redirecting the user terminal to access the service, the system may provides a identifier for use by the service when providing events for recordal, the system storing the events in dependence on the identifier.

The system may include an accounting subsystem, the accounting subsystem receiving events occurring between the service and the user terminal and recording the events against the user's account. The accounting subsystem may communicate with a billing system for billing the user in dependence on events recorded by the accounting subsystem.

The system may include a storage subsystem, the storage subsystem accepting content for supply by the services to user terminals, wherein one or more of the services are arranged to access the content in the storage subsystem for supply to user terminals. Access by a service to content within the storage subsystem may be recorded as an event by the system. A service may access content in the storage subsystem using the identifier, the system being arranged to cross-reference the identifier with data about the user to determine whether the user is permitted to access the content, the system authorising or denying access accordingly.

According to another aspect of the present invention, there is provided a service platform for allowing a user to access remote services using a user terminal via a broadband network, the platform providing accounting, authorization and security modules to the remote services, the authorization and security modules being arranged to accept requests for access to the remote services from users and to authorise access in dependence on data stored about the user by redirecting the user terminal to the remote service, the accounting module being arranged to communicate with the remote service to obtain data on communication between the remote service and the user terminal for subsequent billing of the user.

According to a further aspect of the present invention, there is provided a method of providing access to remote services to a number of user terminals over a broadband network, the method comprising the steps of:

storing data about the services and data about users;

receiving requests from user terminals for access to the services;

authorising access to the services in dependence on the stored data;

using the data stored about the service to redirect the user terminal to access the service; and,

recording subsequent events occurring between the user terminal and the service.

The method man further comprise the step of dynamically generating a user interface for use by a user on a user terminal for accessing the services, the interface being generated in dependence on the data stored about the services and the data stored about the user.

Data stored about a service may include the service's address, wherein the step of using the data may comprise the step of using the address to instruct the user terminal to communicate with the service at the address.

The step of using the data may further comprise the step of providing a identifier for use by the service when providing events for recordal, the step of recording events may comprise storing the events in dependence on the identifier.

The method may further comprise the step of billing the user in dependence on events recorded in the recording step.

According to another aspect of the present invention, there is provided a computer readable medium, on which is stored a computer program of instructions for controlling a general purpose computer to providing access to remote services to a number of user terminals over a broadband network, comprising, in combination:

means for storing, data about the services and data about users in a memory;

means for receiving requests from user terminals for access to the services;

means for authorising access to the services in dependence on the data in the memory;

means for using the data stored about the service to redirect the user terminal to access the service; and,

means for recording subsequent events occurring between the user terminal and the service.

Data about the services may include authentication data for required to access the services, wherein upon authorising access to a service for a user at a user terminal, the system may be arranged to communicate the service's authentication data to the service to authenticate the user at the user terminal for access to the service.

According to another aspect of the present invention, there is provided an intermediate system for offering centralised access and support functions to a plurality of remote systems of digital data service providers comprising accounting, authentication, authorization and security modules, the authentications authorization and security modules being arranged to provide access to the remote systems by checking the authorisation of access requests and redirecting authorised requests to the remote system, the accounting module being arranged to communicate with the remote system to obtain data on resultant access of the system's services for subsequent billing.

The intermediate system may farther comprise an adapter arranged to monitor the remote system to obtain data on resultant access of the system's services and to communicate the data to the accounting module.

The present invention provides a broadband services system that allows new services to be rolled out to users without significant interfacing and development on the part of the service providers or the party maintaining the services system. The system enables broadband access providers to offer value-added services to the end user in a scalable, end-to end solution. The system acts as a middleware platform or portal by providing the necessary security, authorization, authentication and accouting facilities to services required without requiring integration with the user interface.

Management of services and content can be performed centrally at the system or at a service provider's system. As no integration is performed between the system and service application, each can be managed and changed independently to the other.

By treating service applications as “black boxes”, the complexity of the user interface and links between the system and service applications are minimized without reducing functionality. The present invention is applicable to any type of service provision over broadband networks and can operate over any transport medium. Furthermore, whilst specific hardware is advisable for performance and quality of service issues, the present invention can operate on any computer platform that can communicate over a broadband network and is therefore very versatile.

### BRIEF DESCRIPTION OF THE DRAWINGS

Examples of the present invention will now be described in detail with reference to the accompanying drawings, in which:

FIG. 1 is a schematic diagram of a broadband network incorporating a system according to one embodiment of the present invention;

FIG. 2 is a screen shot of a user interface provided to a user terminal by a system according to the present invention;

FIG. 3 is a schematic diagram of a system according to the present invention highlighting selected features in more detail;

FIG. 4 is the schematic diagram of FIG. 3 illustrating alternative features according to an embodiment of the present invention; and,

FIG. 5 is a block diagram illustrating the flow of data in a system according to the present invention.

### DETAILED DESCRIPTION

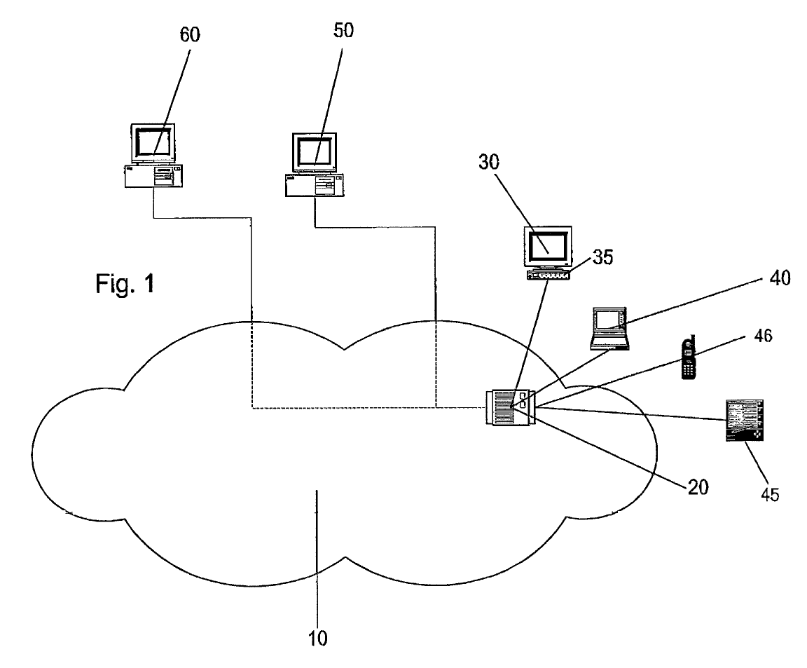

FIG. 1 is a schematic diagram of a broadband network incorporating a system according to one embodiment of the present invention.

A broadband service system 20 is connected to a broadband network 10 and hosts data representing content and services for access by a number of user terminal (30, 35; 40; 45; 46). A user terminal may comprise a television 30 and set-top-box 35 that is appropriately programmed and arranged to communicate with the system 20. Alternatively, a user may be a personal computer 40 equipped with a suitable interface card to allow access to the system 20, a PDA device 45 or mobile telephone 46 configured to allow wireless access to the system 20.

A user accessing the system 20 using his or her user terminal (30, 35; 40; 45; 46) is presented with a logon screen into which he or she must enter a user name and password to verify subscription to the system 20. Upon successfully logging on, the system 20 generates a user interface for the user. The user interface is generated in dependence on the services of the system 20 subscribed to by the user, the availability of chose services and also any other restrictions placed by the network access provider, service provider or subscriber.

Example services that may be offered by the system 20 include video on demand; games on demand; music on demand; multimedia streaming; video chat; application service provision; software on demand; interactive TV; terrestrial, satellite and digital television karaoke on demand security applications such as remote camera monitoring; video conferencing; remote data storage; e-learning; and virtual private network access.

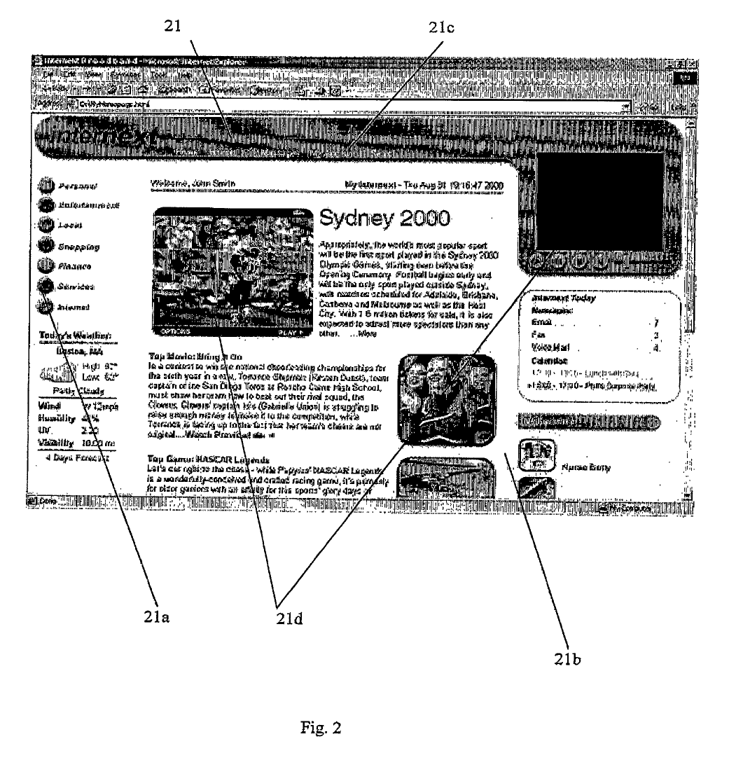

A screenshot of user interface provided to a user terminal by the system 20 is shown in FIG. 2. The user interface includes controls 21a for use in selecting services and associated content, a service and content display area 21b displaying services and content selected by the user and allowing interaction, where necessary, with the services. The interface also includes user controls 21c for allowing the user to amend and update subscription details, to run reports to determine usage and charging of services via the system 20 and to generate sub-users. Sub-users may, for example, children of the subscription holder or employees of a business holding a subscription. The user controls 21c allow the subscription holder to limit or restrict access by sub-users to certain services and data. Furthermore, the reports can be split to show usage and billing per user and sub-user for the subscription. Depending on the services and data selected by the user via the user interface 21, the user interface 21 may also include a service application 21d for displaying the content and/or interacting with a service.

Using the user interface 21, a user is able to navigate the services and content on offer from the system 20 using the user terminal (30, 35; 40; 45; 46) to select services to access or content to be output on the user terminal. For example, a user may navigate to the video on demand section of the system 20 and select to watch a movie. Upon selection of a particular movie, the system 20 cross-references the request with the user's subscription to authenticate the request. If the user's subscription includes video on demand and the user is not restricted from viewing movies of that particular movie's rating, the system 20 triggers the user's terminal 30, 35 to display a video on demand service application. The selected movie is then transmitted to the video on demand application on the user terminal 30, 35 for display to the user. The user can control playback of the movie using controls on the video on demand application. Events associated with the video on demand application on the user terminal are recorded by the system 20 so that the user may be billed for use of the service.

It can be seen that the interface 21 shown in FIG. 2 is a web page displayed in an Internet browser. However, any suitable interface display technology can be used depending on the capabilities of the user terminal. For example, a user interface for a personal computer may be formed from active server pages whilst a user interface for a set-top-box may be a Java applet.

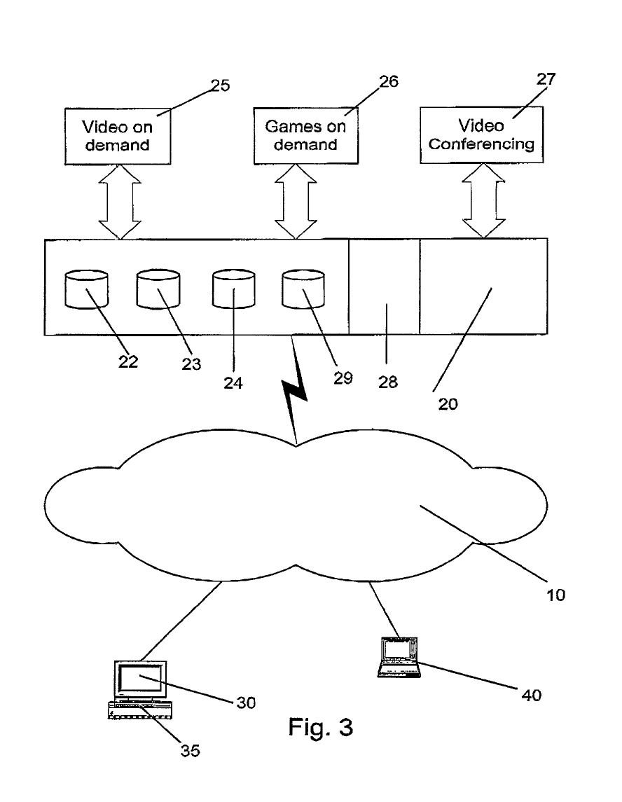

FIG. 3 is a schematic diagram of a system according to the present invention highlighting selected features in more detail. The system 20 includes a user database 22, a content database 23, a service database 24 and an event database 29. The service database 24 includes the name of each available service, the system's user-id and password for use in accessing the service and an address for the service in the form of a Universal Resource Locator (URL). The system also includes security, authorization, authentication, accounting and management modules (not shown). The system 20 may include a billing module or may be linked to a remote billing system (not shown). Furthermore, the system includes a storage module 28 for storing content. The storage module may be made up from hard disks, disks arrays, CD drives, DVD drives, optical devices or any other storage medium. Records in the content database 23 may relate to content stored in the storage module or elsewhere.

The system 20 is in communication with a number of service applications including applications for video on demand 25, games on demand 26 and video conferencing 27, each having their own record in the service database 24.

When a user logs on to the system 20 via a user terminal 40 the system 20 obtains the user's subscription details from the user database 22. In dependence on the subscription details from the user database 22 and also availability of content and services determined from the content database 23 and services database 24, the system 20 generates a user interface page that allows the user to access the available services and content permitted by his or her subscription. This page is transmitted to the user terminal 40 for display to the user. The user navigates using an input device such as a keyboard, mouse, touch screen, voice recognition or a remote control to select buttons, menu items and the like on the page. Navigation of the user interface page results in further pages being generated by the system 20 and transmitted to the user terminal 40 in a similar manner to that experienced when navigating websites using a web browser. Therefore, the user terminal only receives a page or a small number of pages of the user interface at any one time. If the availability of services or content changes whilst the user is browsing, the user interface is updated so frequently that the likelihood of a user selecting unavailable content or services or missing new or updated content or services is minimised.

If the user selects an element in the user interface representing content registered in the content database 23 or a service registered in the service database 24, the security and authorization modules of the system 20 check the user's subscription account in the user database 22 to ensure he or she is authorised to access the content or service.

If the user is found to authorised by having the appropriate settings in the user database 22, the system 20 obtains the record from the service database 24 for the service application associated with the service or content. Using the data obtained, the system 20 communicates with the service application to cause the content or service to be provided to the user terminal 40. Access to the service application is recorded against the user's subscription in the event database 29 for future billing, account usage and reporting purposes. Events resulting from subsequent user interaction with the service application are also recorded in the event database 29. Service applications 25, 26, 27 need not be part of the system 20, indeed, they could be hosted on a remote computer system and could communicate via the network 10.

Content and communications from the service applications, 25, 26, 27 directed to the user terminal 40 does not pass through the system 20. However, interaction is recorded on the system 20 for future billing, reporting and accounting services against the users subscription account.

Where the content is stored in the storage module 28, the service application accesses the content on the system 20 and then supplies it to the user terminal 40.

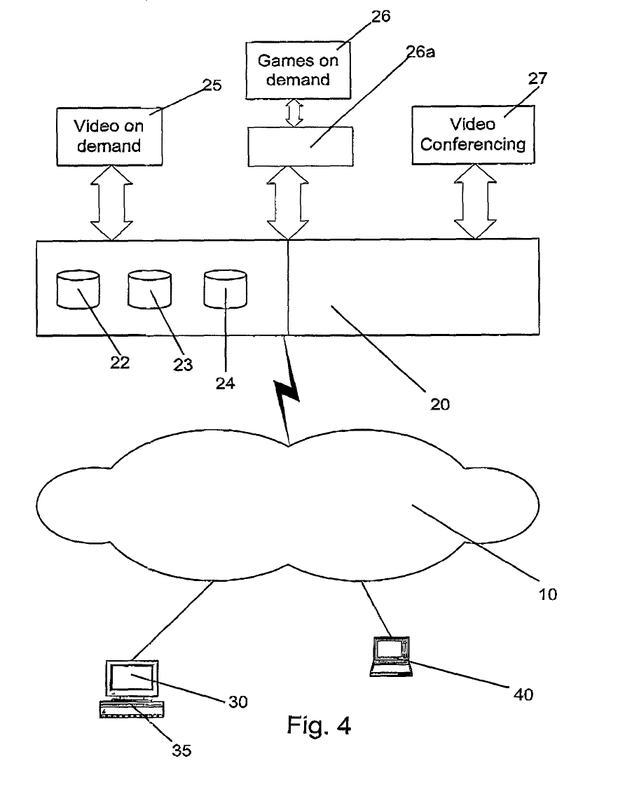

It can be seen that a change to a service application or the addition of a new service application does not effect the operation of the system 20 and can be applied extremely simply. A new application need merely be registered in the services database 24. The communication from the system 20 to the service application, 25, 26, 27 normally includes the network address of the user terminal 40 to which the service or content is to be delivered along with any selection of content and a session identifier for use in reporting events to the system 20.

Where a service application is not specifically written to accept communications from the system 20 and to report user interaction events such as termination, selection of further services, replaying services, an adapter may be provided to the service provider. This is illustrated in FIG. 4. In an example, a games on demand service application 26 may be unable to accept requests directly from the system 20 and/or to report events to the system 20. Therefore an intermediate adapter 26a is installed. The adapter may reside at the site of the system 20 or at a site of the service application 26 (if different). The adapter 26a receives requests from the system 20 and translates them into requests acceptable by the service application 26. In addition, the adapter 26a captures user interaction events at the service application 26a and translates them into events for submission to the system 20 for billing of the user.

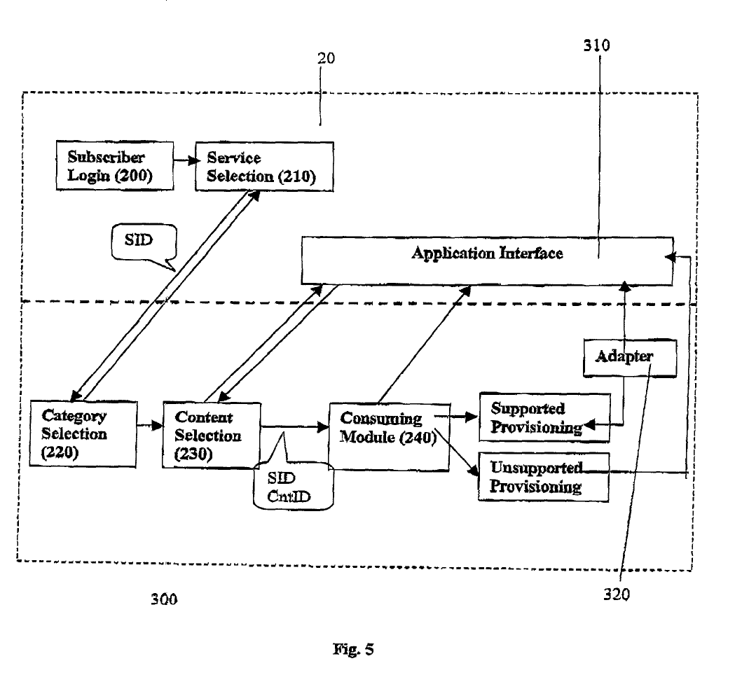

FIG. 5 is a block diagram illustrating the flow of data in a system according to the present invention in more detail. In step 200, a subscriber logs into the system 20. Using the user interface, the user selects a service to access in step 210. The system accesses the service database 24 to determine the appropriate user ID and password for the service and the URL for the service. The system maintains an account with each service and logs the user into the service using the User ID and password for this account. In this manner, the user need only remember user ID and password for the system which in turn allows direct access to other services that the user would otherwise require accounts and passwords for.

The user's terminal is redirected to communicate with the URL of the service allowing the user direct access to the service system 300. During the redirection process, the service system 300 is provided an identifier, a session IT (SID), for use in referring to events during the user's use of the system 300. The user is guided through a category selection step 220, such as genre, by a user interface provided by the service system 300 and is then offered content to access in step 230. To determine the content available, the service system 300 communicates with an application interface 310 within the system 20 which in turn obtains data on the content the user is authorised to access from the content database 23 and using the user database 22.

An interface is presented by the services system 300 to the user terminal listing content available from the system 20 and any content available directly from the service system 300. Once content is selected from the list, the application interface 310 authorises access by issuing a further identifier, a content identifier (CID), identifying the content and the content ID and session ID are passed to a consuming module. The consuming module uses the identifiers to obtain the content and feeds the content data a step 240 to the user's terminal. Events such as the start or stop of content provision (consumption) to a user's terminal, access of further content or services and the like are passed to the application interface 310. If the services system 300 is written to support event passing using the SID, this data is passed directly to the application interface. Otherwise, an adapter 320 monitors the provision of the content and converts events to those understood by the application interface 310.

Preferably, communication between the system 20 and service applications is via XML over HTTP, however, any suitable language over any suitable communications protocol can be used.

Whilst the above examples have been described with reference to specific user terminals, network configurations and database schema, it will be appreciated that the present invention is applicable to existing and future variations. For example, the databases may be combined to form separate tables in a single database or split into multiple databases, possibly hosted by different computer systems.

Furthermore, it will be appreciated from the above description that the present invention provides a broadband services system that allows new services to be rolled out to users without significant interfacing and development on the part of the service providers or the party maintaining the services system. The system acts as a middleware platform by providing the necessary security, authorization, authentication and accounting facilities required without requiring integration with the user interface. By treating service applications as “black boxes”, the complexity of the user interface and links between the system 20 and service applications are minimized without reducing functionality. The present invention is applicable to any type of service provision over broadband networks and can operate over any transport medium. Furthermore, whilst specific hardware is advisable for performance and quality of service issues, the present invention can operate on any computer platform that can communicate over a broadband network and is therefore very versatile.

The system 20 is not limited to specific platform types or user terminal types and could be implemented for user terminals ranging from, for example, desktop computers to mobile telephones.

It will be apparent that storage systems and subsystems, memories and other data storage units referred to in this application could be any suitable data storage medium from hard disks, CD drvies, optical storage devices or any other available technology.

1. A broadband system for providing access to remote services to a number of user terminals over a broadband network, the system storing data about the services and data about users, wherein the system is arranged to receive requests from user terminals for access to the services and to authorise access to the services in dependence on the stored data, wherein upon authorising access to a service for a user at a user terminal, the system is arranged to use the data stored about the service to redirect the user terminal to access the service and to record subsequent events occurring between the user terminal and the service.

2. A system according to claim 1, in which the system is arranged to dynamically generate a user interface for use by a user on a user terminal for accessing the services, the interface being generated in dependence on the data stored about the services and the data stored about the user.

3. A system according to claim 2, in which data stored about a service includes data on the availability of the service, wherein a user interface only allows access to a service if the data indicates it is available.

4. A system according to claim 3, in which access to a service from the user interface is via link, wherein a generated user interface only includes a link to a service if the data indicates it is available.

5. A system according to claim 2, in which data stored about a user includes data on a user's subscription to the system, wherein a user interface only allows access to a service if the data on the user's subscription indicates the user's subscription covers that service.

6. A system according to claim 5, in which access to a service from the user interface is via a link, wherein a generated user interface only includes a link to a service if the user's subscription covers that service.

7. A system according to claim 2, in which data stored about a user includes data on restrictions to access of services from the system, wherein a user interface only allows access to a service if the data on restrictions does not prohibit access to the service.

8. A system according to claim 7, in which access to a service from the user interface is via a link, wherein a generated user interface only includes a link to a service if the user is not restricted from accessing that service.

9. A system according to claim 1, in which the data stored about a service includes the service's address, wherein upon authorising access, the system uses the address to instruct the user terminal to communicate with the service at the address.

10. A system according to claim 1, wherein the or each service is arranged to communicate events that occur between the user terminal and the service to the system for recordal.

11. A system according to claim 1, further comprising an adapter for passing communications and events between a service and the system, the adapter being arranged to capture and convert necessary communications and events from the service into a form processable by the system and to transmit them to the system for recordal.

12. A system according to claim 1, wherein when redirecting the user terminal to access the service, the system provides an identifier for use by the service when providing events for recordal, the system storing the events in dependence on the identifier.

13. A system according to claim 1, including an accounting subsystem, the accounting subsystem receiving events occurring between the service and the user terminal and recording the events against the user's account.

14. A system according to claim 13, in which the accounting subsystem communicates with a billing system for billing the user in dependence on events recorded by the accounting subsystem.

15. A system according to claim 1, including a storage subsystem, the storage subsystem accepting content for supply by the services to user terminals, wherein one or more of the services are arranged to access the content in the storage subsystem for supply to user terminals.

16. A system according to claim 15, in which access by a service to content within the storage subsystem is recorded as an event by the system.

17. A system according to claim 15, wherein when redirecting the user terminal to access the service, the system provides an identifier for use by the service when providing events for recordal, the system storing the events in dependence on the identifier.

18. A system according to claim 17, in which a service accesses content in the storage subsystem using the identifier, the system being arranged to cross-reference the identifier with data about the user to determine whether the user is permitted to access the content, the system authorizing or denying access accordingly.

19. A service platform for allowing a user to access remote services using a user terminal via a broadband network, the platform providing accounting, authentication, authorization and security modules to the remote services, the authorization and security modules being arranged to accept requests for access to the remote services from users and to authorise access in dependence on data stored about the user by redirecting the user terminal to the remote service, the accounting module being arranged to communicate with the remote service to obtain data on communication between the remote service and the user terminal for subsequent billing of the user.

20. A method of providing access to remote services to a number of user terminals over a broadband network, the method comprising the steps of:
storing data about the services and data about users;
receiving requests from user terminals for access to the services;
authorising access to the services in dependence on the stored data;
using the data stored about the service to redirect the user terminal to access the service; and,
recording subsequent events occurring between the user terminal and the service.

21. A method according to claim 20, further comprising the step of authenticating a user requesting access to the services at a user terminal using the data about users, wherein the data about services includes authentication data for use in accessing the services, the step of using the data further comprising the step of using the authentication data for the service to authenticate the user at the user terminal with the service.

22. A method according to claim 20, further comprising the step of dynamically generating a user interface for use by a user on a user terminal for accessing the services, the interface being generated in dependence on the data stored about the services and the data stored about the user.

23. A method according to claim 20, in which the data stored about a service includes the service's address, wherein the step of using the data comprises the step of using the address to instruct the user terminal to communicate with the service at the address.

24. A method according to claim 23, wherein the step of using the data further comprises the step of providing an identifier for use by the service when providing events for recordal, the step of recording events comprising storing the events in dependence on the identifier.

25. A method according to claim 20, further comprising the step of billing the user in dependence on events recorded in the recording step.

26. A computer readable medium, on which is stored a computer program of instructions for controlling a general purpose computer to providing access to remote services to a number of user terminals over a broadband network, comprising, in combination:
means for storing data about the services and data about users in a memory;
means for receiving requests from user terminals for access to the services;
means for authorising access to the services in dependence on the data in the memory;
means for using the data stored about the service to redirect the user terminal to access the service; and,
means for recording subsequent events occurring between the user terminal and the service.

27. A computer readable medium according to claim 26, further comprising means for authentication a request for access to the services in dependence on the data about users, wherein the data about the services includes authentication data for accessing the services, wherein the means for using the data includes means for using the authentication data to authenticate the user terminal with the service.

28. A program storage device readable by a machine and encoding a program of instructions for executing the method steps of claim 20.

29. A system according to claim 1, in which the data about the services includes authentication data for required to access the services, wherein upon authorising access to a service for a user at a user terminal, the system is arranged to communicate the service's authentication data to the service to authenticate the user at the user terminal for access to the service.

30. An intermediate system for offering centralised access and support functions to a plurality of remote systems of digital data service providers comprising accounting, authentication, authorization and security modules, the authentication, authorization and security modules being arranged to provide access to the remote systems by checking the authorisation of access requests and redirecting authorised requests to the remote system, the accounting module being arranged to communicate with the remote system to obtain data on resultant access of the system's services for subsequent billing.

31. An intermediate system according to claim 31, further comprising an adapter arranged to monitor the remote system to obtain data on resultant access of the system's services and to communicate the data to the accounting module.
